(19) United States
(12) Patent Application Publication
(10) Pub. No.: US 2025/0329483 A1
(43) Pub. Date: Oct. 23, 2025

(54) THERMAL REGULATION OF RESISTORS USING PHASE CHANGE MATERIAL

(71) Applicant: Caterpillar Inc., Peoria, IL (US)

(72) Inventor: Trevor J Smith, Peoria Heights, IL (US)

(73) Assignee: Caterpillar Inc., Peoria, IL (US)

(21) Appl. No.: 18/638,874

(22) Filed: Apr. 18, 2024

(51) Int. Cl. H01C 1/08; H01C 1/02; H01C 17/02

(52) U.S. Cl. CPC H01C 1/08; H01C 1/02; H01C 17/02

(57) ABSTRACT

A resistor assembly for a precharge circuit of a power system is described. The resistor assembly includes at least one resistor configured to control one or more instances of inrush current from a power source of the power system to a capacitor of the power system and generate one or more heat impulses corresponding to the one or more instances of inrush current. The resistor assembly includes a container filled with a phase change material (PCM) and the resistor embedded in the PCM. The PCM absorbs thermal energy associated with the one or more heat impulses by changing a state of the PCM from a first state to a second state. When the state of the PCM changes to the second state, the resistor remains embedded or immersed in the PCM to receive additional thermal energy corresponding to additional instances of inrush current.

### TECHNICAL FIELD

The present disclosure relates to thermal regulation of resistors, for example, in a pre-charge circuit. More particularly, the present disclosure relates to thermal regulation of resistors using a phase change material.

### BACKGROUND

Electric machines generally manage inrush current (e.g., a sudden surge of an electrical current) in their high-voltage systems when they are turned/switched on. To this end, electric machines employ and/or utilize pre-charge circuits, including a resistor circuit, to control and limit the inrush current. The resistor circuit typically controls the inrush current by dissipating thermal energy that accompanies the inrush current. Excess inrush current and/or repeated instances of an inrush current in short durations can damage components of the electric machine and/or shorten their lifespan.

U.S. Pat. No. 9,036,352 B2 describes a heat dissipating assembly, for dissipating heat, having at least one heat producing component and a heat sink having phase change material conductively coupled to the at least one heat producing component.

### SUMMARY OF THE INVENTION

In an aspect, the present disclosure relates to a resistor assembly for a precharge circuit of a power system. The resistor assembly includes at least one resistor configured to control one or more instances of inrush current from a power source of the power system to a capacitor of the power system and generate one or more heat impulses corresponding to the one or more instances of inrush current. The resistor assembly further includes a container filled with a phase change material (PCM) and the at least one resistor embedded in the PCM. The PCM absorbs thermal energy associated with the one or more heat impulses by changing a state of the PCM from a first state to a second state to dissipate the thermal energy away from the at least one resistor. When the state of the PCM changes to the second state, the at least one resistor remains embedded or immersed in the PCM to receive additional thermal energy corresponding to additional instances of inrush current.

In another aspect, the present disclosure relates to a power system. The power system includes a power source to run a load, a capacitor coupled with the load, and a resistor assembly including at least one resistor configured to control one or more instances of inrush current from the power source to the capacitor and generate one or more heat impulses corresponding to the one or more instances of inrush current. The resistor assembly further includes a container filled with a phase change material (PCM) and the at least one resistor embedded in the PCM. The PCM absorbs thermal energy associated with the one or more heat impulses by changing a state of the PCM from a first state to a second state to dissipate the thermal energy away from the at least one resistor. When the state of the PCM changes to the second state, the at least one resistor remains embedded or immersed in the PCM to receive additional thermal energy corresponding to additional instances of inrush current.

In yet another aspect, the present disclosure relates to a method of manufacturing a resistor assembly for a precharge circuit of a power system. The method includes arranging at least one resistor in a container. The at least one resistor controls one or more instances of inrush current from a power source of the power system to a capacitor of the power system and generates one or more heat impulses corresponding to the one or more instances of inrush current. The method further includes introducing a phase change material (PCM) into the container to embed the at least one resistor in the PCM. The PCM absorbs thermal energy associated with the one or more heat impulses by changing a state of the PCM from a first state to a second state to dissipate the thermal energy away from the at least one resistor. When the state of the PCM changes to the second state, the at least one resistor remains embedded or immersed in the PCM to receive additional thermal energy corresponding to additional instances of inrush current.

### BRIEF DESCRIPTION

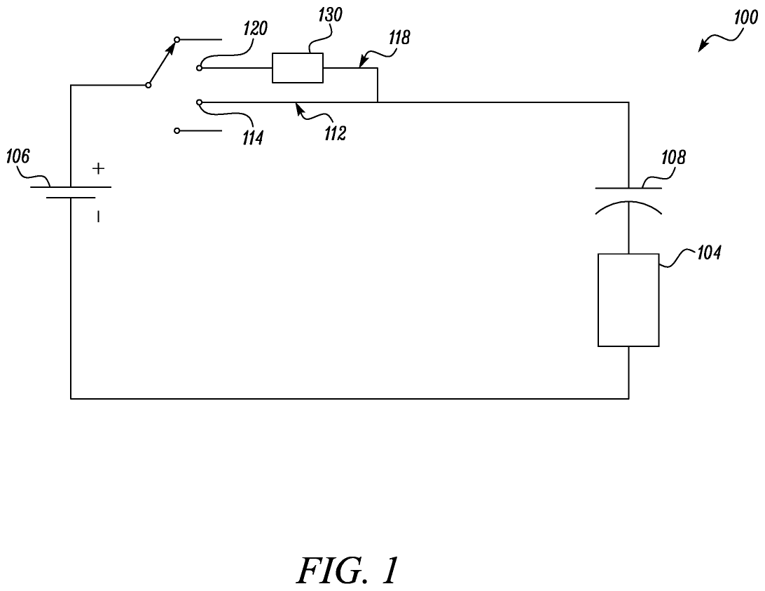

FIG. 1 is a circuit diagram of an exemplary power system including a precharge circuit with a resistor assembly for controlling inrush current, in accordance with an embodiment of the present disclosure;

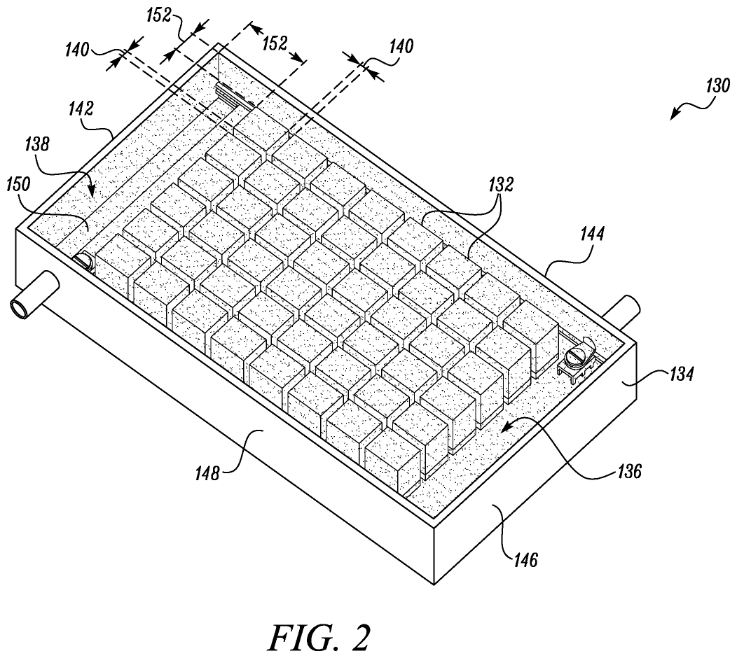

FIG. 2 is an interior view of the resistor assembly of FIG. 1, in accordance with an embodiment of the present disclosure;

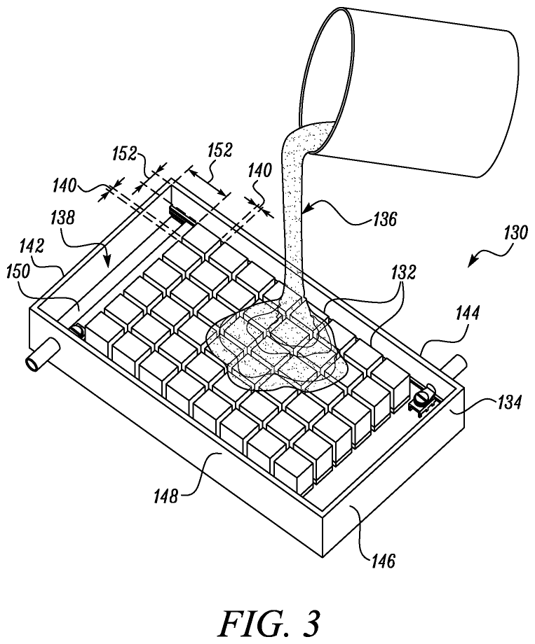

FIG. 3 illustrates an exemplary step of manufacturing the resistor assembly of FIG. 1, in accordance with an embodiment of the present disclosure; and

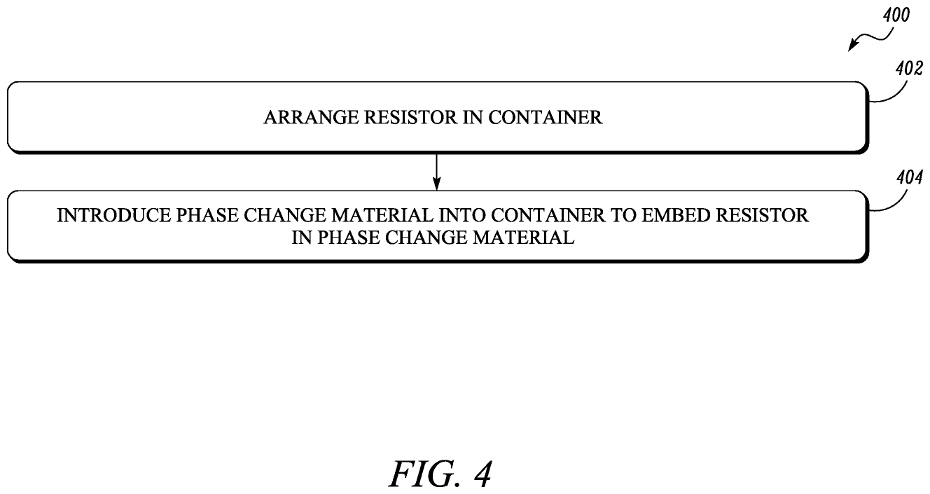

FIG. 4 is a method for manufacturing the resistor assembly for the precharge circuit of the power system of FIG. 1, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

Referring to FIG. 1, an exemplary power system 100 is described. The power system 100 may be applied in a work machine (e.g., an electrical work machine) (not shown) which may be employable at a worksite to perform one or more activities, e.g., earthmoving, construction, etc., at the worksite. To this end, the work machine may be a mobile machine that can traverse between various locations of the worksite, although aspects of the present disclosure may be contemplated and applied for various other types of machines, e.g., stationary work machines, such as generator sets. In some examples, the work machine may include one or more loads (e.g., see load 104), which may represent one or more electrically operable devices or apparatuses that may be manipulated to perform one or more of the aforesaid activities. As an example, said devices or apparatuses may include and/or correspond to an actuator of an implement (e.g., a blade, a bucket, or a screed) that may be applied for engaging and/or altering earth. Further, as an example, said devices or apparatuses may include and/or correspond to motors associated with traction devices (not shown) of the work machine that may be applied for moving the work machine from one location of the worksite to another location of the worksite.

With continued reference to FIG. 1, the power system 100 may include a power source 106, such as a battery, that may produce or generate electrical energy to run the load 104 of the aforesaid work machine. The power source 106 may be a direct current (DC) battery, an alternating current (AC) grid connection, or any other suitable power source depending on the application.

The power system 100 may also include a capacitor 108 coupled with the load 104, for example, in series. For example, the capacitor 108 may be a DC link capacitor. The capacitor 108 may be configured to store the energy from the power source 106 and provide a relatively stable DC voltage. The DC voltage from the capacitor 108 may be further provided to an inverter (not shown), which in turn may convert the DC voltage into AC voltage for running the load 104. In some embodiments, the capacitor 108 may be a part of such an inverter.

The power system 100 may include a main power supply circuit 112 to provide or supply the electrical energy from the power source 106 to the capacitor 108 (e.g., through a flow of current) for running the load 104 and thus performing one or more of the aforesaid activities of the work machine. The electrical energy from the power source 106 may be supplied to the capacitor 108 via the main power supply circuit 112 when the power source 106 is connected to the main power supply circuit 112 via a first switch 114. For example, the first switch 114 may be configured to facilitate the transfer of the electrical energy from the power source 106 to the capacitor 108 via the main power supply circuit 112 when in a closed position and restrict the transfer of the electrical energy from the power source 106 to the capacitor 108 via the main power supply circuit 112 when in an open position. For example, the first switch 114 may be a contactor that can be switched between an open position and a closed position to control or regulate the transfer of the electrical energy from the power source 106 to the capacitor 108 via the main power supply circuit 112.

The power system 100 also includes a precharge circuit 118 configured to provide or supply regulated or controlled electrical energy (e.g., by regulating or controlling a flow of inrush current) from the power source 106 to the capacitor 108, e.g., when the power system 100 is first activated/energized, such as when the work machine is turned/switched on for operation and/or movement). In such scenarios, electrical energy from the power source 106 may be transferred (e.g., relatively gradually) to the capacitor 108 via the precharge circuit 118 to protect one or more components (e.g., downstream components) of the power system 100 from the inrush current. In accordance with various embodiments, the inrush current may represent a transient surge of current that may occur due to a voltage difference between the power source 106 and the capacitor 108 at the moment of an activation of the power system 100.

As an exemplary operation, electrical energy from the power source 106 may be supplied to the capacitor 108 via the precharge circuit 118 when the power source 106 is connected to the precharge circuit 118 via a second switch 120. For example, the second switch 120 may be configured to facilitate the transfer of the electrical energy from the power source 106 to the capacitor 108 via the precharge circuit 118 when in a closed position and restrict the transfer of the electrical energy from the power source 106 to the capacitor 108 via the precharge circuit 118 when in an open position. For example, the second switch 120 may be a contactor that can be switched between an open position and a closed position to control the transfer of the electrical energy from the power source 106 to the capacitor 108 via the precharge circuit 118.

The precharge circuit 118 includes a resistor assembly 130 to control one or more instances of the inrush current from the power source 106 to the capacitor 108. The resistor assembly 130 is configured to control (e.g., limit) the flow of the inrush current to the capacitor 108, e.g., during an initial charging of the capacitor 108, such as at the initialization of the power system 100. Once the capacitor 108 reaches a designated voltage, the precharge circuit 118 is disconnected by moving the second switch 120 to the open position, and the electrical energy from the power source 106 is supplied to the capacitor 108 via the main power supply circuit 112 by moving the first switch 114 to the closed position.

FIG. 2 describes the resistor assembly 130 for the precharge circuit 118 of the power system 100, in accordance with various embodiments. The resistor assembly 130 includes one or more resistors 132 and a container 134. The resistors 132 may be configured to control (i.e., restrict or limit) one or more instances of the inrush current from the power source 106 to the capacitor 108, for example, by introducing an impedance. The resistors 132 may be further configured to generate one or more heat impulses corresponding to the flow of one or more instances of the inrush current through the resistors 132. In some embodiments, when there are more than one resistors 132, the resistors 132 may be connected in series. In some embodiments, and as exemplarily shown in FIG. 2, the resistors 132 may be placed within an interior 138 of the container 134 and may be arrayed according to a grid pattern or layout, defining multiple resistor rows and multiple resistor columns. Each individual resistor 132 may correspondingly define gaps 140 with respect to adjacently positioned resistors 132.

Although not limited, the container 134 may include a cuboidal profile with exemplarily four (4) sidewalls 142, 144, 146, 148, one top wall (which is removed from the view of FIG. 2 in order to reveal the interior 138 of the container 134 and particularly the resistors 132 arranged therewithin in the grid pattern or layout), and one bottom wall 150. Apart from defining gaps 140 with respect to adjacent resistors 132, each individual resistor 132 may also correspondingly define clearances 152 with respect to adjacent portion of a sidewall 142, 144, 146, 148 of the container 134. In some embodiments, the container 134 may be an electrically insulated container made from one or more insulated materials, such as high-grade plastic(s) and/or polymer(s). As an example, the top wall of the container 134 may be openable and closeable so as to selectively provide access to the interior 138 of the container 134, as and when needed. Further, the exemplary grid pattern or layout of the resistors 132 may significantly fill-out an area defined by the bottom wall 150, and, in some embodiments, the grid pattern or layout may cover anywhere between 80% to 90% of the area defined by the bottom wall 150 but may leave enough clearance 152 on its sides with respect to the sidewalls 142, 144, 146, 148 of the container 134. Although not shown, it would be appreciated that the container 134 may include any shape, such as cylindrical, circular, and so on, and thus the cuboidal profile of the container 134 is exemplary and non-limiting.

The container 134 may include and/or be filled with a phase change material (PCM) 136. The PCM 136 may correspond to a substance that changes its state from a first state to a second state when a predetermined amount of heat is absorbed, and further changes its phase from the second state back to the first state when the predetermined amount of heat is released. The first state may correspond to a solid state and the second state may correspond to a liquid state, although other states (such as states that are intermediate to the solid state and liquid state) are also possible. The above reference to the PCM 136 being filled into the container 134 may be applicable during a production of the resistor assembly 130 during which the interior 138 of the container 134 may first receive the resistors 132 in the grid pattern or layout and then the interior 138 be filled with the PCM 136 (e.g., in a liquid state or a semi-liquid state) such that as the container 134 is filled with the PCM 136, the PCM 136 can seep past the resistors 132 and settle into the above described gaps 140 and/or clearances 152 defined between the resistors 132 and between the resistors 132 and the sidewalls 142, 144, 146, 148 of the container 134, as shown in FIG. 3. In so doing, the resistors 132 are immersed into the PCM 136. Further, once the PCM 136 solidifies in the container 134, the resistors 132 become embedded into the PCM 136.

In accordance with various embodiments, a latent heat of the PCM 136 to change from the first state to the second state is greater than a specific heat of the PCM 136. For example, the PCM 136 includes one or more of paraffin wax, polyethylene glycol, polyalcohol, polyethylene, or any other PCM now known or in the future developed.

In accordance with various embodiments, the resistors 132 may be embedded in the PCM 136 (e.g., this is applicable when the PCM 136 is in a solid state) and the heat impulses generated by the resistors 132 are conductively transferred to the PCM 136. The PCM 136 is configured to absorb a thermal energy associated with the heat impulses by changing a state of the PCM 136 from the first state to the second state to dissipate the thermal energy away from the resistors 132. The PCM 136 is further configured to dissipate the thermal energy away from the resistors 132 to an environment surrounding the resistor assembly 130 by returning from the second state to the first state, e.g., during a precharge circuit downtime (i.e., when the precharge circuit 118 is not in use or is non-operational for a period). The PCM 136 may be configured to repeatedly change its state from the first state to the second state, and back to the first state, reliably for multiple cycles.

In accordance with various embodiments, the container 134 may be a sealed container that prevents leakage of the PCM 136 from the container 134 and also protects one or more components (such as, the PCM 136, the resistors 132) inside the container 134 from external contaminants, such as dust, moisture, and other environmental elements. Further, the container 134 may correspond to a closed system, e.g., that exchanges thermal energy dissipated by the resistors 132 with its surrounding environment but mitigates (or altogether avoids) any loss of the PCM 136 filled or housed within the interior 138 of the container 134.

### INDUSTRIAL APPLICABILITY

In accordance with various embodiments, when the power system 100 is first initialized, the PCM 136 is configured to absorb the heat impulses generated by the resistors 132. At this stage, the PCM 136 may change its state from the first state to the second state to dissipate the thermal energy associated with the heat impulses away from the resistors 132. The PCM 136 may then dissipate the thermal energy away from the resistors 132 to an environment surrounding the resistor assembly 130 by returning from the second state to the first state during the precharge circuit downtime.

When the state of the PCM 136 changes to the second state, the resistors 132 remain embedded or immersed in the PCM 136 to receive additional thermal energy corresponding to additional instances of inrush current. In some instances, the precharge circuit 118 may be used multiple times within a short interval of time resulting in the generation of multiple additional instances of inrush current within the short interval. In such cases, the additional instances of inrush current are required to be absorbed by the PCM 136 before the PCM 136 can dissipate the thermal energy corresponding to previous instances of inrush current to the environment. To this end, the PCM 136 is configured to further absorb supplementary heat, beyond the heat causing the phase change to occur, even after the state of the PCM 136 changes from the first state to the second state. The PCM 136 may then dissipate the absorbed thermal energy to the environment during the precharge circuit downtime. Therefore, the PCM 136 is able to take repeated heat impulses, thereby helping keep the resistors 132 in a working temperature range for the most part of a precharge circuit operation.

FIG. 4 describes an exemplary method 400 for manufacturing the resistor assembly 130 for the precharge circuit 118 of the power system 100. The method 300 includes arranging the resistors 132 in the container 134 at step 402 and introducing the PCM 136 into the container 134 to embed the resistors 132 in the PCM 136 at step 404 (as shown in FIG. 3). In accordance with various embodiments, the PCM 136 may be introduced in the container 134 in various manners known in the art, for example, but not limited, to changing the state of the PCM 136 to a liquid state and then pouring the PCM 136 in the liquid state into the container 134 housed with the resistors 132 such that the resistors 132 are embedded or immersed in the PCM 136.

During operations, it is known for excess inrush current and/or repeated instances of an inrush current occurring frequently or in short durations to overheat components of the work machine. To deal with instances of inrush currents, a large number of resistors 132 are generally used to provide sufficient thermal regulation so as not to overheat the components of the work machine. The need to have a large number of resistors 132 in the precharge circuit 118 further increases if the temperature of an ambient surrounding the container 134 is relatively high.

The resistor assembly 130 of the present disclosure allows effective absorption of excess inrush current and/or repeated instances of an inrush current. By embedding the resistors 132 in the PCM 136, the thermal energy corresponding to an inrush current can be effectively absorbed by the PCM 136 by changing its state from the first state to the second state. Moreover, the PCM 136 can effectively absorb additional thermal energy corresponding to additional instances of inrush current even after the state of the PCM 136 changes from the first state to the second state. This prevents any overheating or damage to the components of the work machine, as the thermal energy absorbed by the PCM 136 is slowly dissipated to the environment during the precharge circuit downtime. Moreover, the use of the PCM 136 results in an effective thermal regulation of the resistors 132, thereby reducing the overall number of resistors 132 required in the precharge circuit 118 for absorbing excess inrush current and/or repeated instances of an inrush current.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A resistor assembly for a precharge circuit of a power system, the resistor assembly comprising:
at least one resistor configured to control one or more instances of inrush current from a power source of the power system to a capacitor of the power system and generate one or more heat impulses corresponding to the one or more instances of inrush current; and
a container filled with a phase change material (PCM) and the at least one resistor embedded in the PCM, wherein the PCM absorbs thermal energy associated with the one or more heat impulses by changing a state of the PCM from a first state to a second state to dissipate the thermal energy away from the at least one resistor, wherein
when the state of the PCM changes to the second state, the at least one resistor remains embedded or immersed in the PCM to receive additional thermal energy corresponding to additional instances of inrush current.

2. The resistor assembly of claim 1, wherein the first state corresponds to a solid state and the second state corresponds to a liquid state.

3. The resistor assembly of claim 1, wherein the PCM dissipates the thermal energy away from the at least one resistor to an environment surrounding the resistor assembly by returning from the second state to the first state during a precharge circuit downtime.

4. The resistor assembly of claim 1, wherein the container is a sealed container to correspond to a closed system.

5. The resistor assembly of claim 1, wherein the one or more heat impulses generated by the at least one resistor are conductively transferred to the PCM.

6. The resistor assembly of claim 1, wherein a latent heat of the PCM to change from the first state to the second state is greater than a specific heat of the PCM.

7. The resistor assembly of claim 1, wherein the PCM is one or more of paraffin wax, polyethylene glycol, polyalcohol, and polyethylene.

8. The resistor assembly of claim 1, wherein the container is an electrically insulated container.

9. A power system, comprising:
a power source to run a load;
a capacitor coupled with the load;
a resistor assembly including:
at least one resistor configured to control one or more instances of inrush current from the power source to the capacitor and generate one or more heat impulses corresponding to the one or more instances of inrush current; and
a container filled with a phase change material (PCM) and the at least one resistor embedded in the PCM, wherein the PCM absorbs thermal energy associated with the one or more heat impulses by changing a state of the PCM from a first state to a second state to dissipate the thermal energy away from the at least one resistor, wherein
when the state of the PCM changes to the second state, the at least one resistor remains embedded or immersed in the PCM to receive additional thermal energy corresponding to additional instances of inrush current.

10. The power system of claim 9, wherein the first state corresponds to a solid state and the second state corresponds to a liquid state.

11. The power system of claim 9, wherein the PCM dissipates the thermal energy away from the at least one resistor to an environment surrounding the resistor assembly by returning from the second state to the first state during a precharge circuit downtime.

12. The power system of claim 9, wherein the container is a sealed container to correspond to a closed system.

13. The power system of claim 9, wherein the one or more heat impulses generated by the at least one resistor are conductively transferred to the PCM.

14. The power system of claim 9, wherein a latent heat of the PCM to change from the first state to the second state is greater than a specific heat of the PCM.

15. The power system of claim 9, wherein the PCM is one or more of paraffin wax, polyethylene glycol, polyalcohol, and polyethylene.

16. The power system of claim 9, wherein the container is an electrically insulated container.

17. A method of manufacturing a resistor assembly for a precharge circuit of a power system, the method comprising:
arranging at least one resistor in a container, wherein the at least one resistor controls one or more instances of inrush current from a power source of the power system to a capacitor of the power system and generates one or more heat impulses corresponding to the one or more instances of inrush current; and
introducing a phase change material (PCM) into the container to embed the at least one resistor in the PCM, wherein the PCM absorbs thermal energy associated with the one or more heat impulses by changing a state of the PCM from a first state to a second state to dissipate the thermal energy away from the at least one resistor, wherein
when the state of the PCM changes to the second state, the at least one resistor remains embedded or immersed in the PCM to receive additional thermal energy corresponding to additional instances of inrush current.

18. The method of claim 17, wherein a latent heat of the PCM to change from the first state to the second state is greater than a specific heat of the PCM.

19. The method of claim 17, wherein the PCM is one or more of paraffin wax, polyethylene glycol, polyalcohol, and polyethylene.

20. The method of claim 17, wherein the container is a sealed container to correspond to a closed system.
